(19) United States
(12) Patent Application Publication
(10) Pub. No.: US 2018/0020451 A1
(43) Pub. Date: Jan. 18, 2018

(54) High Capacity Layered Wireless Communications System

(71) Applicant: Phazr, Inc., Allen, TX (US)

(72) Inventors: Farooq Khan, Allen, TX (US); Robert Clark Daniels, Austin, TX (US); Eran Pisek, Allen, TX (US); Khurram Muhammad, Fort Worth, TX (US); Khalil Haddad, Allen, TX (US); Paul Gilliland, Allen, TX (US)

(21) Appl. No.: 15/602,093

(22) Filed: May 22, 2017

Related U.S. Application Data
(60) Provisional application No. 62/363,221, filed on Jul. 16, 2016.

(51) Int. Cl. H04W 72/04; H04W 88/08; H04W 84/12

(52) U.S. Cl. CPC H04W 72/0453; H04W 84/12; H04W 88/08

(57) ABSTRACT

A high-capacity wireless communications network for wireless broadband link comprises a radio base station configured to transmit first millimeter-wave band signals and a plurality of wireless access points configured to receive the first millimeter wave band signals. The wireless access points are operable to convert the first millimeter wave band signals to first lower frequency band signals and operable to transmit the first lower frequency band signals to communications devices. The wireless access points are configured to receive second lower frequency band signals from the communications devices and operable to convert the second lower frequency band signals to second millimeter wave band signals and operable to transmit the second millimeter wave band signals to the radio base station. The radio base station is configured to receive the second millimeter wave band signals and operable to process the second millimeter wave band signals.

### BACKGROUND

The invention generally relates to wireless communications, and in particular to a high capacity layered wireless communications system.

### DESCRIPTION OF THE RELATED ART

Currently, wireless access methods are based on two popular standards: a wide area network (WAN) standard referred to as The Fourth Generation Long Term Evolution (4G LTE) system; and a local area network (LAN) standard called Wi-Fi. Wi-Fi is generally used indoors as short-range wireless extension of wired broadband systems. The 4G LTE system on the other hand provides wide area long-range connectivity both outdoors and indoors using dedicated infrastructure such as cell towers and backhaul to connect to the Internet.

As more people connect to the Internet, increasingly chat to friends and family, watch videos, listen to streamed music, and indulge in virtual or augmented reality experiences, data traffic continues to grow at unprecedented rates. In order to address the continuously growing wireless capacity challenge, the next generation of LAN and WAN systems are expected to rely on higher frequencies referred to as millimeter waves.

At millimeter wave frequencies, radio spectrum use is lighter, and very wide bandwidths along with a large number of smaller antennas can be used to provide the increase in capacity needed. The smaller size of antennas is enabled by carrier waves that are millimeters long compared to centimeter-long waves at lower frequencies. A drawback of millimeter waves frequencies, however, is that they tend to lose more energy than do lower frequencies over long distances because they are readily absorbed or scattered by gases, rain, and foliage as well as experience higher losses when penetrating through structures such as walls or other building materials.

### BRIEF SUMMARY OF THE INVENTION

The present invention is directed to a high-capacity layered wireless communications system that relies on both high-frequency and low-frequency spectrum bands. The high-frequency millimeter wave bands are used for communication between large form-factor radio base stations and medium form factor wireless access points while the low-power small form-factor mobile devices communicate with the wireless access points and the radio base stations using conventional low-frequency radio spectrum below 6 GHz.

According to disclosed embodiments, a high-capacity wireless communications network for wireless broadband link comprises a radio base station configured to transmit first millimeter-wave band signals and a plurality of wireless access points configured to receive the first millimeter wave band signals. The wireless access points are operable to convert the first millimeter wave band signals to first lower frequency band signals and operable to transmit the first lower frequency band signals. The wireless access points are configured to receive second lower frequency band signals and operable to convert the second lower frequency band signals to second millimeter wave band signals and operable to transmit the second millimeter wave band signals to the radio base station. The radio base station is configured to receive the second millimeter wave band signals and operable to process the second millimeter wave band signals.

According to disclosed embodiments, the radio base station is configured to receive data via a wired communications link and operable to process the data and to generate the first millimeter wave band signals. The wireless communications network includes a plurality of communications device configured to receive the first lower frequency band signals and to transmit the second lower frequency band signals.

According to disclosed embodiments, the radio base station comprises a first millimeter wave band array antenna configured to transmit the first millimeter wave band signals and to receive the second millimeter wave band signals. The wireless access point comprises a second millimeter wave band antenna configured to receive the first millimeter wave band signals and to transmit the second millimeter wave band signals.

According to disclosed embodiments, responsive to the data received via the wired communications link, the radio base station generates a third lower frequency band signals. The third lower frequency band signals comprise a plurality of third lower frequency band groups. The third lower frequency bands are upconverted and shifted to the first millimeter wave band signals. The second millimeter wave bands are down-converted and shifted to fourth lower frequency band groups.

According to disclosed embodiments, the first millimeter wave band signals are down-converted to first lower frequency band signals. The second lower frequency band signals are up-converted to second millimeter wave band signals.

According to disclosed embodiments, the lower frequency band signals are sub-6 GHz signals and the millimeter wave band signals are greater than 15 GHz signals.

According to disclosed embodiments, a high-capacity wireless communications network for wireless broadband link comprises a radio base station linked to a wide area network via a wired communication link. The radio base station is configured to receive first data via the wired communication link and operable to convert the first data to first millimeter-wave band signals and operable to transmit the first millimeter-wave band signals. The radio base station is configured to receive second millimeter wave band signals from a plurality of wireless access points and operable to convert the second millimeter wave band signals to second data and operable to transmit the second data via the wired communication link. The radio base station comprises a first millimeter wave band array antenna configured to transmit the first millimeter wave band signals and to receive the second millimeter wave band signals.

According to disclosed embodiments, a high-capacity wireless communications network for a wireless broadband link comprises a wireless access point configured to receive first millimeter wave band signals from a radio base station. The wireless access point is operable to convert the first millimeter wave band signals to first lower frequency band signals and operable to transmit the first lower frequency band signals to a communications device. The wireless access point is configured to receive second lower frequency band signals from the communications device and operable to convert the second lower frequency band signals to second millimeter-wave band signals and operable to transmit the second millimeter-wave band signals.

### BRIEF DESCRIPTION OF THE DRAWINGS

FIGS. 1A-1B illustrate a high-capacity layered wireless communications system in accordance with disclosed embodiments.

FIG. 2 shows frequency translation, stacking and up-conversion performed by a radio base station.

FIG. 3 illustrates a wireless access point according to disclosed embodiments.

FIG. 4 illustrates a wireless access point in accordance with another embodiment of the invention.

FIG. 5 illustrates a wireless access point in accordance with yet another embodiment of the invention.

FIG. 6 illustrates a wireless communications chain implemented in a radio base station.

FIG. 7 illustrates a wireless access point in accordance with disclosed embodiments.

FIG. 8 illustrates up-conversion and transmission of Wi-Fi and LTE bands at high frequency according to disclosed embodiments.

FIG. 9 illustrates an embodiment where a radio base station serves nine wireless access points on three spatial beams.

### DETAILED DESCRIPTION AND BEST MODE OF IMPLEMENTATION

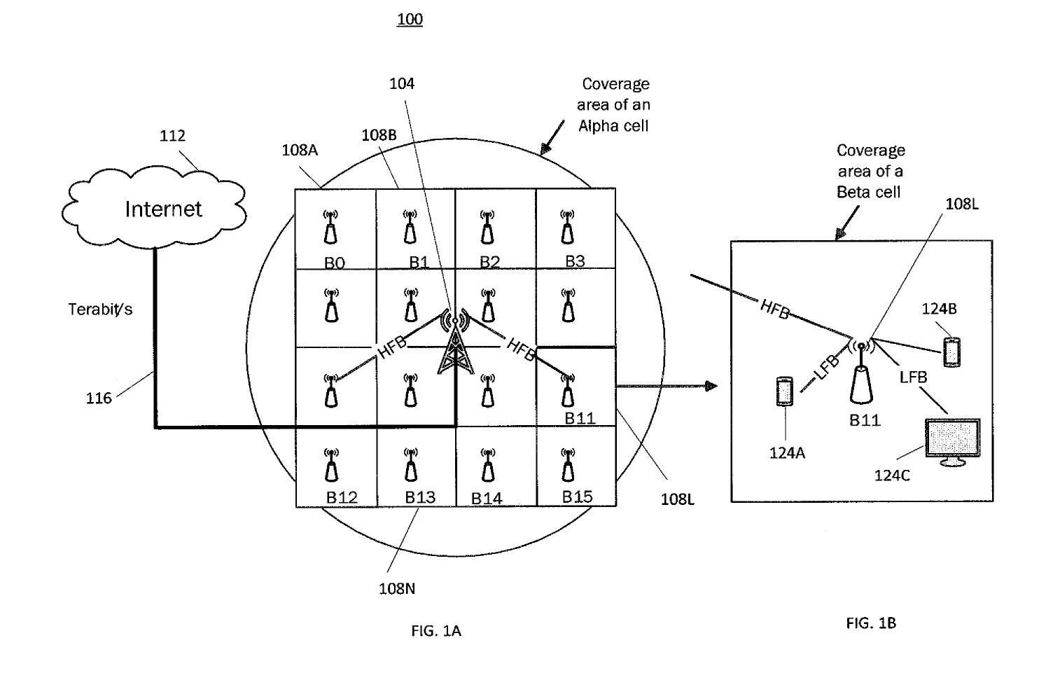

FIG. 1A illustrates a high-capacity layered wireless communications system 100 in accordance with disclosed embodiments. The system 100 includes a radio base station 104 configured to provide services to a plurality of wireless access points 108A-108N in a coverage area. The radio base station 104 is also referred to herein as an alpha cell and the wireless access points are referred to as beta cells. Thus, an alpha cell is configured to provide services to many beta cells within a coverage area. Although only one radio base station 104 or alpha cell is shown, the system 100 includes a plurality of radio base stations each providing coverage to a plurality of wireless access points 108A-108N.

Referring to FIG. 1A, the radio base station 104 is connected to a wide area network such as the Internet 112 via a wired communication link 116. The wired communication link 116 may be a high-speed link such as a fiber optic link or any other type of communications link. The radio base station 104 receives data via the wired communication link 116.

According to some disclosed embodiments, the wireless access points 108A-108N provide service to a plurality of communication devices in their coverage area using Low Frequency bands (LFB) below 6 GHz and do not have wired backhaul links. For example, as shown in FIG. 1B, the wireless access point 108L provides service to communication devices 124A-124C using low frequency bands. The communication devices may, for example, be mobile phones, laptop or desktop computers, or televisions. These low frequency bands are attractive for communication with devices both outdoor and indoor due to their favorable propagation characteristics in non-line-of-sight (NLOS) situations and due to their ability to bend around and penetrate through obstacles easily. Also, these low frequency bands allow low-power small form-factor mobile devices transmit and receive signals on conventional radio spectrum below 6 GHz without the need for transmission or reception at higher millimeter wave frequency.

According to disclosed embodiments, the links between the radio base station 104 and the wireless access points 108A-108N use Higher Frequency Bands (HFB) above 6 GHz commonly referred to as millimeter wave bands. At high frequency bands, radio spectrum use is lighter, and very wide bandwidths along with large antenna arrays can be used to provide capacities needed to serve a large number of wireless access points from a radio base station.

According to disclosed embodiments, the wireless access points 108A-108N provide service to the communication devices in their coverage area using Low Frequency bands (LFB) below 6 GHz such as those used by 4G LTE and Wi-Fi systems. The links between the radio base station 104 and the wireless access points 108A-108N use Higher Frequency Bands (HFB) above 6 GHz commonly referred to as millimeter wave bands shown in Table 1.

TABLE 1
Examples of millimeter wave bands

| | | Frequency | Bandwidth |
|---|---|---|---|
| Bands [GHz] | | [GHz] | [GHz] |
| 24 | GHz Bands | 24.25-24.45 | 0.200 |
| | | 25.05-25.25 | 0.200 |
| LMDS Band | | 27.5-28.35 | 0.850 |
| | | 29.1-29.25 | 0.150 |
| | | 31-31.3 | 0.300 |
| 39 | GHz Band | 38.6-40 | 1.400 |
| 37/42 | GHz Bands | 37.0-38.6 | 1.600 |
| | | 42.0-42.5 | 0.500 |
| 60 | GHz | 57-64 | 7.000 |
| | | 64-71 | 7.000 |
| 70/80 | GHz | 71-76 | 5.000 |
| | | 81-86 | 5.000 |
| 90 | GHz | 92-94 | 2.900 |
| | | 94.1-95.0 | |
| 95 | GHz | 95-100 | 5.000 |
| 105 | GHz | 102-105 | 7.500 |
| | | 105-109.5 | |
| 112 | GHz | 111.8-114.25 | 2.450 |
| 122 | GHz | 122.25-123 | 0.750 |
| 130 | GHz | 130-134 | 4.000 |
| 140 | GHz | 141-148.5 | 7.500 |
| | | 151.5-155.5 | |
| 150/160 | GHz | 155.5-158.5 | 12.50 |
| | | 158.5-164 | |

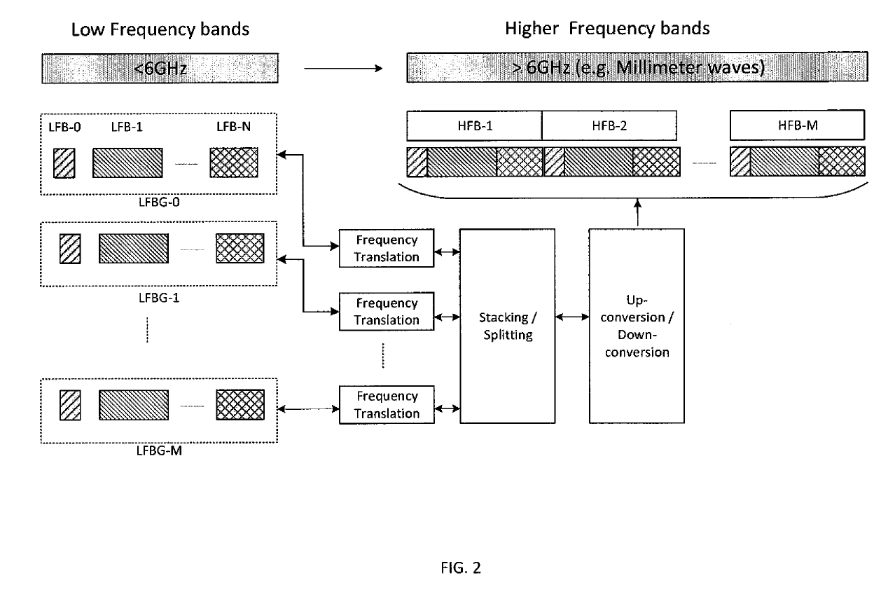

FIG. 2 shows operations of frequency bands translation, stacking and up-conversion performed by the radio base station 104. The radio base station 104 receives data via the wired link and converts the data into low frequency band signals. As shown in FIG. 2, at the radio base station 104, M lower frequency band groups (LFBG) each consisting of up to N low frequency bands are shifted in frequency, stacked, and up-converted to higher frequency bands for transmission. The radio base station 104 receives higher frequency band signals from the wireless access points, which are down-converted, split and frequency shifted into multiple (M) lower frequency band groups and finally each group is split into N low frequency bands.

The stacking of multiple low frequency bands and the band-groups for transmission at higher frequency bands provide for the capacities needed to serve many wireless access points (e.g., 108A-108N) from a single radio base station 104. Each low frequency band-group is mapped to a different higher frequency band. In the implementation shown in FIG. 2, low frequency band group number zero (LFBG-0) is mapped to higher frequency band number zero (HFB-0), low frequency band group number one (LFBG-1) is mapped to higher frequency band number one (HFB-1), and so forth with low frequency band group number M (LFBG-M) mapped to higher frequency band number M (HFB-M).

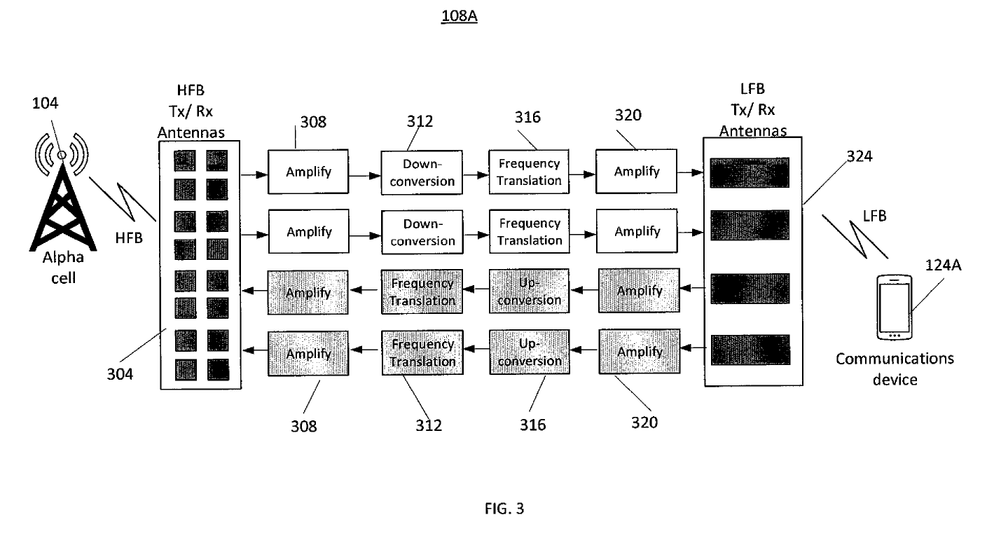

FIG. 3 illustrates an architecture of one of the wireless access points (e.g., 108A) according to disclosed embodiments. The wireless access point 108A implement Analog, RF and Antenna functions. The high frequency signals from the radio base station 104 are received by antenna array 304 and are amplified by amplifiers 308. The amplified signals are down-converted to lower frequency by down-conversion modules 312 and the frequencies are translated to appropriate low bands by frequency translation modules 316. The lower frequency signals are again amplified by amplifiers 320 and finally transmitted by antenna array 324. The transmitted lower frequency signals are received by the communication device 124A.

In the reverse direction, the wireless access point 108A receives low frequency band signals from the communication device 124A. The low frequency band signals are translated are amplified by amplifiers 320 and up-converted by up-converters 316 to higher frequency bands. The up-converted signals are translated to appropriate frequency bands by frequency translation modules 312, amplified again by amplifiers 308, and transmitted to the radio base station 104 by the antenna array 304.

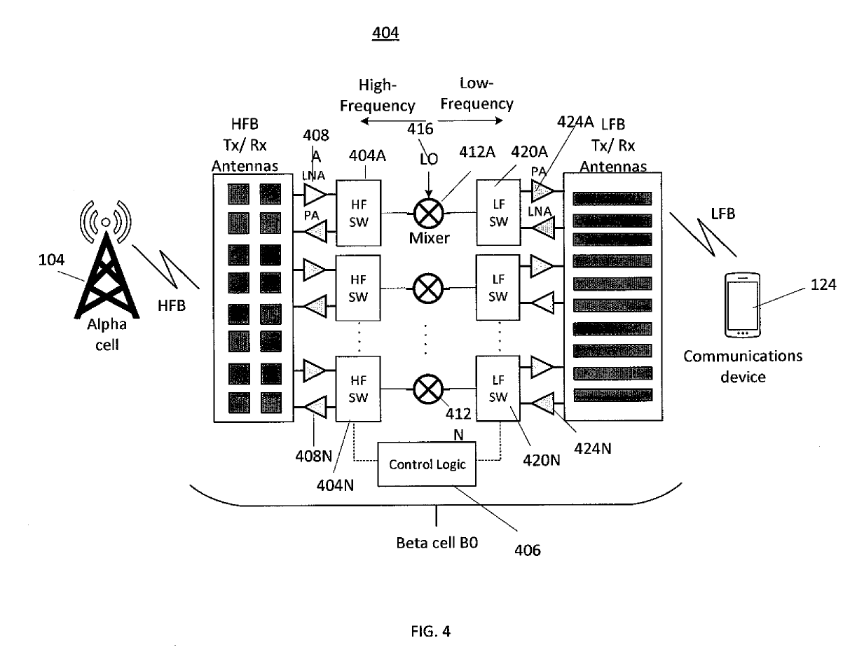

FIG. 4 illustrates a wireless access point 404 in accordance with another embodiment of the invention. The wireless access point 404 features switches to eliminate transmit signals feeding back into receive chains. The wireless access point 404 receives high frequency signals from the radio base station 104. The wireless access point 404 includes high frequency switches (HFSW) 404A-404N which open paths to high frequency Low-noise amplifiers (LNA) 408A-408N. A logic circuit 406 controls the state of the switches 404A-404N.

The received signals are amplified by LNAs 408A-408N and then down-converted to a lower frequency by mixers 412A-412N driven by a local oscillator (LO) 416. The wireless access point 404 includes low-frequency switches (LFSW) 420A-420N controlled by the logic circuit 406 which opens the paths to low frequency power amplifier (PA) 424A-424N for signal transmission to the communication device 124.

When the wireless access point 404 transmits low-frequency signal, the low frequency receive chain path is disabled to avoid the transmit signal leaking back into the receive chain path. Similarly, when the wireless access point 404 receives low frequency signals from the communication device 124, the low-frequency transmit paths are disabled while opening the high-frequency transmit paths.

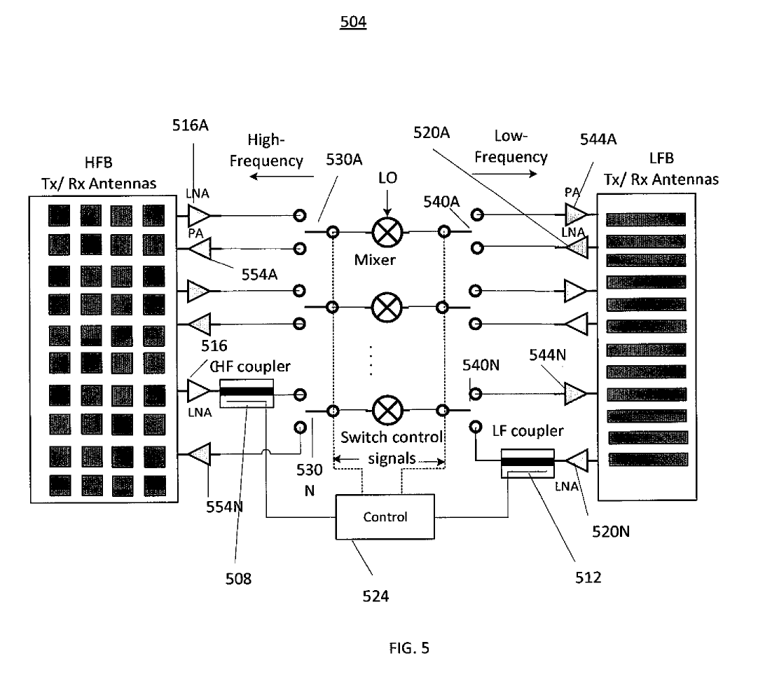

FIG. 5 illustrates a wireless access point 504 in accordance with yet another embodiment of the invention. In the implementation illustrated in FIG. 5, the wireless access point 504 includes a high frequency coupling device 508 and a low frequency coupling device 512 connected to a control circuit 524. The high frequency coupling device 508 is configured to detect high frequency signals by tapping into received signals at the output of a low noise amplifier 516. The low frequency coupling device 512 is configured to detect low frequency signals by tapping into received signals at the output of a low noise amplifier 520. In yet other embodiments of the invention, dedicated low-frequency and high-frequency antennas can be used by a control circuit for detecting the low frequency and high frequency signals without the need for coupling devices.

When the control circuit 524 detects high-frequency signals from the radio base station 104, the control circuit 524 turns the high frequency switches (HFSW) 530A-530N to open the paths to the high-frequency Low-noise amplifiers (LNA) 534A-534N. The received signals are then down-converted to a lower frequency by using mixers driven by a local oscillator (LO). The control circuit 524 also turns low-frequency switches (LFSW) 540A-540N to open the paths to the low frequency power amplifiers (PA) 544A-544N for signal transmission to the communication device 124.

When the control circuit 524 detects low-frequency signals from the communication devices, it turns the low frequency switches (LFSW) 540A-540N to open the paths to the low-frequency Low-noise amplifiers (LNA) 520A-520N. The control circuit 524 also turns the high-frequency switches (HFSW) 530A-530N to open the paths to high-frequency power amplifiers (PA) 554A-554N for signal transmission to the radio base station 104.

When the wireless access point 504 is transmitting low-frequency signals, the low frequency receive chain (LNA) path is disabled to avoid the transmit signal leaking back into the receive chain. Likewise, when the wireless access point 504 is receiving low frequency signals from the communication devices, the low-frequency transmit paths are disabled while opening the high-frequency transmit paths.

When the access point 504 is transmitting high-frequency signals, the high-frequency receive chain (LNA) path is disabled to avoid the high-frequency transmit signals leaking back into the receive chain. Similarly, when the access point 504 is receiving high-frequency signals from the radio base station 104, it turns off the high-frequency transmit paths while opening the low-frequency transmit paths.

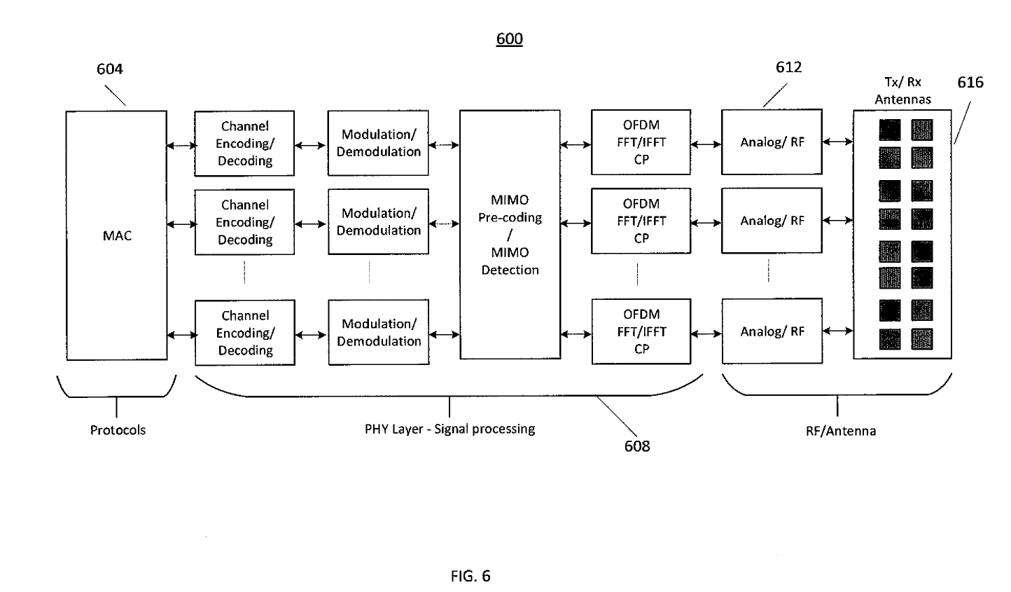

FIG. 6 illustrates a wireless communications chain 600 implemented in the radio base station 104 according to some disclosed embodiments. The radio base station 104 implements major functions including Medium Access Control (MAC) 604, Physical (PHY) layer 608, Analog/RF functions 612 and antenna 616 for each of the frequency bands. In contrast, some wireless access points may not implement the MAC and PHY layer functions but only implement Analog, RF and antenna functions, thereby simplifying its architecture.

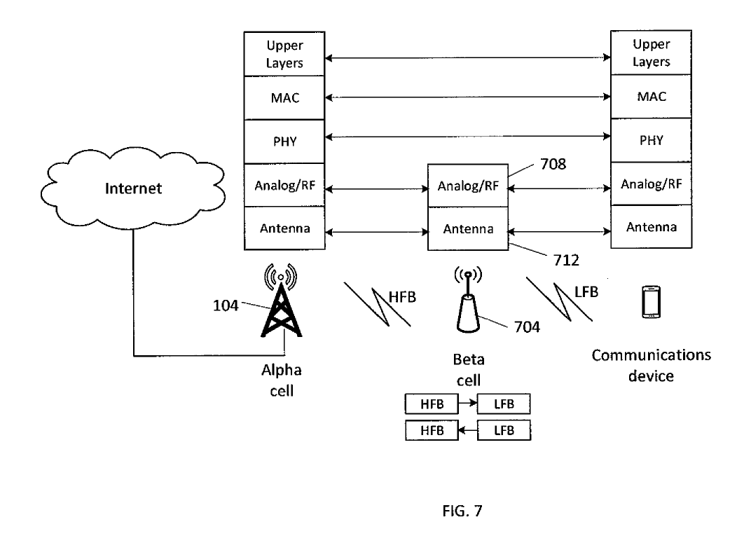

FIG. 7 illustrates a wireless access point 704 in accordance with some disclosed embodiments. The wireless access point 704 implements Analog/RF 708 and Antenna 712 functions only. As a consequence, the wireless access point 704 is transparent to the MAC/PHY and upper layers communication between the wireless access point 704 and the radio base station 104 as shown in FIG. 7, thereby simplifying the network and RF performance management as the radio base station 104 has direct visibility into the status of all wireless access points in its coverage area.

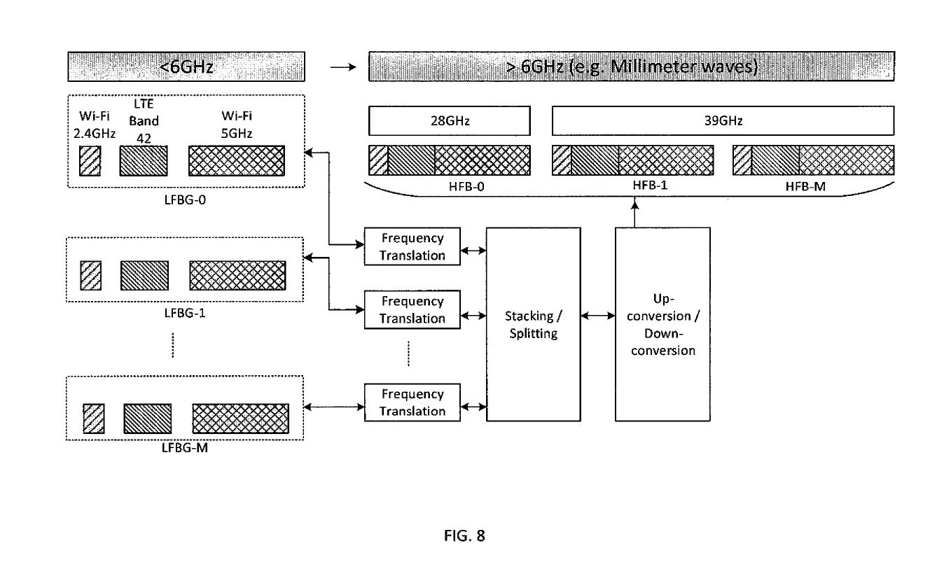

FIG. 8 illustrates up-conversion and transmission of Wi-Fi and LTE bands at high frequency according to some disclosed embodiments. As shown in FIG. 8, Wi-Fi (2.4/5 GHz) and LTE band 42 (3.4-3.6 GHz) are up-converted and transmitted at high frequency (28/39 GHz) bands. If Wi-Fi 2.4/5 GHz and LTE Band 42 (3.4-3.6 GHz) are used without up-conversion, the bandwidth available in a system is limited to the sum of the bandwidths in these three bands. By using up-conversion and transmission at a higher frequency, the available bandwidth increases by a factor M where M is the number of low frequency band groups or equivalently the number of high frequency bands.

Referring to FIG. 8, a single low frequency band group is mapped to a single high frequency band. Low frequency band group number zero (LFBG-0) is mapped to high frequency band zero (HFB-0) at 28 GHz frequency while low frequency band group number one through M (LFBG-1 to LFBG-M) are mapped to high frequency band one through M (HFB-1 to HFB-M) at 39 GHz frequency.

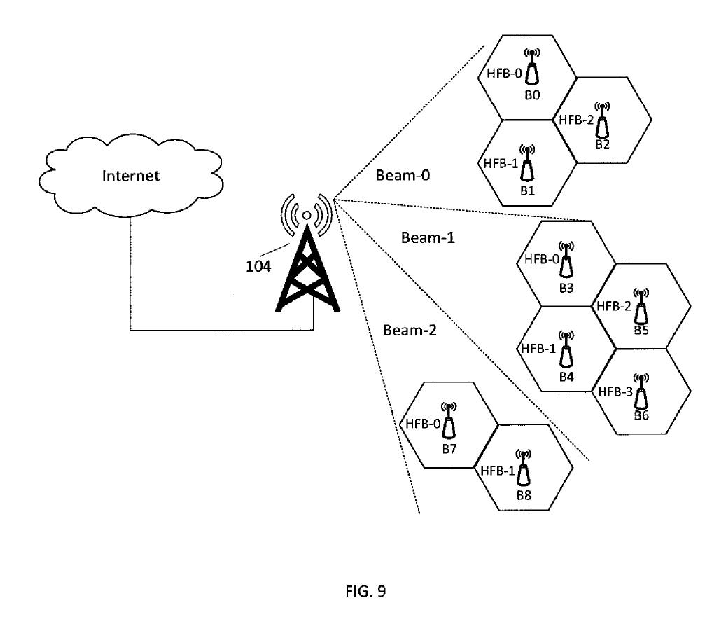

FIG. 9 illustrates an embodiment where the radio base station 104 serves nine wireless access points on three spatial beams by up-converting and transmitting Wi-Fi 2.4/5 GHz and LTE bands 42 (3.4-3.6 GHz) at high frequency 28/39 GHz bands. In spatial beam number one (Beam-1), wireless access point B3 receives its signals on high frequency band number zero (HFB-0) at 28 GHz, wireless access point B4 receives its signals on high frequency band number 1 (HFB-1) at 39 GHz, wireless access point B5 receives its signals on high frequency band number 2 (HFB-2) at 39 GHz, wireless access point B6 receives its signals on high frequency band number 3 (HFB-3) at 39 GHz.

On spatial Beam-0, wireless access points B0, B1 and B2 receive their signals on HFB-0, HFB-1 and HFB-2 respectively. On spatial Beam-2, wireless access points B7 and B8 receive their signals on HFB-0 and HFB-1 respectively. After receiving the high frequency signals, the wireless access points down-convert the high frequency bands to lower frequency bands and transmit these lower frequency signals to the communication devices.

In the reverse direction, the wireless access points receive low frequency signals from the communication devices, up-convert these lower frequency signals into higher frequency signals and transmit to the radio base station 104. For example, wireless access points B0, B1 and B2 in beam-0 in up-convert the signals to high frequency band number 0, 1 and 2 (HFB-0, HFB-1 and HFB-2) respectively for transmission to the radio base station 104.

As each high frequency band contains a lower frequency band group containing multiple lower frequency bands such as Wi-Fi 2.4/5 GHz and LTE Band 42 (3.4-3.6 GHz), the disclosed embodiments enable use of the lower frequency bands in the wireless access points for communication to and from the communication devices.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

What is claimed is:

1. A high-capacity wireless communications network for wireless broadband link, comprising:
a radio base station configured to transmit first millimeter-wave band signals;
a plurality of wireless access points configured to receive the first millimeter wave band signals, the wireless access points operable to convert the first millimeter wave band signals to first lower frequency band signals and operable to transmit the first lower frequency band signals,
the wireless access points configured to receive second lower frequency band signals, the wireless access points operable to convert the second lower frequency band signals to second millimeter wave band signals and operable to transmit the second millimeter wave band signals to the radio base station,
the radio base station configured to receive the second millimeter wave band signals, the radio base station operable to process the second millimeter wave band signals.

2. The wireless communications network of claim 1, wherein the radio base station is configured to receive data via a wired communications link and operable to process the data and to generate the first millimeter wave band signals.

3. The wireless communications network of claim 1, further comprising a plurality of communications device configured to receive the first lower frequency band signals and to transmit the second lower frequency band signals.

4. The wireless communications network of claim 1, wherein the radio base station is connected to a wide area network via the wired communication link.

5. The wireless communications network of claim 1, wherein the radio base station comprises a first millimeter wave band array antenna configured to transmit the first millimeter wave band signals and to receive the second millimeter wave band signals.

6. The wireless communications network of claim 1, wherein the wireless access point comprises a second millimeter wave band antenna configured to receive the first millimeter wave band signals and to transmit the second millimeter wave band signals.

7. The wireless communications network of claim 1, wherein the wide area network is the Internet.

8. The wireless communications network of claim 1, wherein responsive to the data received via the wired communications link, the radio base station generates a third lower frequency band signals.

9. The wireless communications network of claim 1, wherein the third lower frequency band signals comprise a plurality of third lower frequency band groups,

10. The wireless communications network of claim 1, wherein the third lower frequency bands are upconverted and shifted to the first millimeter wave band signals.

11. The wireless communications network of claim 1, wherein the second millimeter wave bands are down-converted and shifted to fourth lower frequency band groups.

12. The wireless communications network of claim 1, wherein the first millimeter wave band signals are down-converted to first lower frequency band signals.

13. The wireless communications network of claim 1, wherein the second lower frequency band signals are up-converted to second millimeter wave band signals.

14. The wireless communications network of claim 1, wherein the lower frequency band signals are sub-6 GHz signals.

15. The wireless communications network of claim 1, wherein the millimeter wave band signals are greater than 15 GHz signals.

16. A high-capacity wireless communications network for wireless broadband link, comprising:
a radio base station linked to a wide area network via a wired communication link, the base station configured to receive first data via the wired communication link,
the radio base station operable to convert the first data to first millimeter-wave band signals and operable to transmit the first millimeter-wave band signals,
the radio base station configured to receive second millimeter wave band signals from a plurality of wireless access points, the radio base station operable to convert the second millimeter wave band signals to second data and operable to transmit the second data via the wired communication link.

17. The wireless communications network of claim 16, wherein the radio base station comprises a first millimeter wave band array antenna configured to transmit the first millimeter wave band signals and to receive the second millimeter wave band signals.

18. The wireless communications network of claim 16, wherein the wide area network is the Internet.

19. The wireless communications network of claim 16, wherein the radio base station converts the first data to third lower frequency band signals.

20. The wireless communications network of claim 16, wherein the third lower frequency band signals comprise a plurality of third lower frequency band groups,

21. The wireless communications network of claim 16, wherein the third lower frequency bands are upconverted and shifted to the first millimeter wave band signals.

22. The wireless communications network of claim 16, wherein the second millimeter wave bands are down-converted and shifted to fourth lower frequency band groups.

23. The wireless communications network of claim 16, wherein the fourth lower frequency band groups are converted to the second data.

24. The wireless communications network of claim 16, wherein the lower frequency band signals are sub-6 GHz signals.

25. The wireless communications network of claim 16, wherein the millimeter wave band signals are greater than 15 GHz signals.

26. A high-capacity wireless communications network for a wireless broadband link, comprising:
a wireless access point configured to receive first millimeter wave band signals from a radio base station, the wireless access point operable to convert the first millimeter wave band signals to first lower frequency band signals and operable to transmit the first lower frequency band signals to a communications device,
the wireless access point configured to receive second lower frequency band signals from the communications device,
the wireless access point operable to convert the second lower frequency band signals to second millimeter-wave band signals and operable to transmit the second millimeter-wave band signals.

27. The wireless communications network of claim 26, wherein the wireless access point comprises a first antenna array configured to receive the first millimeter wave band signals and to transmit the second millimeter wave band signals.

28. The wireless communications network of claim 26, wherein the wireless access point comprises a second antenna array configured to transmit the first lower frequency band signals and to receive the second lower frequency band signals.

29. The wireless communications network of claim 26, wherein the first millimeter wave band signals are down-converted and translated to the first lower band signals.

30. The wireless communications network of claim 26, wherein the second lower frequency band signals are up-converted and translated to the second millimeter wave band signals.

31. The wireless communications network of claim 26, wherein the lower frequency band signals are sub-6 GHz signals.

32. The wireless communications network of claim 26, wherein the millimeter wave band signals are greater than 15 GHz signals.

33. The wireless communications network of claim 26, wherein the communications device is a mobile communication device.

34. The wireless communications network of claim 26, wherein the communications device is a laptop computer.

35. The wireless communications network of claim 26, wherein the communications device is a desktop computer.
